(19) United States
(12) Patent Application Publication
(10) Pub. No.: US 2025/0377882 A1
(43) Pub. Date: Dec. 11, 2025

(54) Vehicle Control Device

(71) Applicant: Hitachi Astemo, Ltd., Hitachinaka-shi, Ibaraki (JP)

(72) Inventors: Takeshi FUKUDA, Chiyoda-ku, Tokyo (JP); Masashi MIZOGUCHI, Chiyoda-ku, Tokyo (JP); Koji MAEDA, Hitachinaka-shi, Ibaraki (JP); Tomohito EBINA, Hitachinaka-shi, Ibaraki (JP); Takashi MURAKAMI, Hitachinaka-shi, Ibaraki (JP)

(21) Appl. No.: 18/876,722

(22) PCT Filed: May 31, 2023
(86) PCT No.: PCT/JP2023/020283

§ 371 Date: Dec. 19, 2024

(30) Foreign Application Priority Data
Jul. 8, 2022 (JP) 2022-110451

(51) Int. Cl. G06F 8/65

(52) U.S. Cl. CPC G06F 8/65

(57) ABSTRACT

There are provided a first arithmetic operation unit and a second arithmetic operation unit. Here, it is determined as to whether the entire structure of new software can be updated in the first arithmetic operation unit or a part of the structure of the new software should be changed in arrangement to be in the second arithmetic operation unit, from information held by a resource information holding unit, based on the state of execution in the first arithmetic operation unit, and the structure of the new software to be newly implemented. When a part of the structure of the new software should be changed in arrangement to be in the second arithmetic operation unit, a part of the structure of the new software to be arranged in the second arithmetic operation unit is determined, in consideration of latencies in both the arithmetic operation units.

### TECHNICAL FIELD

The present invention relates to vehicle control devices.

### BACKGROUND ART

There are techniques for updating software implemented in vehicle control devices (ECUs: Electronic Control Units) after product releases. Electronic control for vehicles is being increasingly upgraded year by year. Therefore, it is valuable to constantly implement latest control software in vehicles, by updating software after product releases. However, such vehicle control devices have limited amounts of hardware resources, such as processor performance and amounts of memories, in many cases. Therefore, software updating methods capable of effectively utilizing such limited hardware resources are regarded as being effective.

For example, PTL1 describes a technique for updating software by arranging modules to be updated, in the order of dependency, according to software update information, further calculating the free capacity of a storage unit, and changing the order of updating of the modules, in such a way as to prevent shortage of the free capacity. This enables updating software, even when the free capacity for storing the modules is smaller than the capacity of the software to be updated, for example.

### CITATION LIST

### Patent Literature

PTL1: JP 2007-213189 A

### SUMMARY OF INVENTION

### Technical Problem

With the technique described in PTL1, it is possible to update software, by changing the order of updating the modules, even when the free capacity of the storage unit for storing the modules is small. However, it is impossible to update software beyond the storage capacity of one system. This has been inducing the following problem. That is, for example, in a system having a long product life, such as a system to be used in units of 10 years, the limit of the available free capacity is reached, thereby making it impossible to update software due to exhaustion of the hardware resource.

It is an object of the present invention to provide a vehicle control device that enables updating software even when hardware resources may be exhausted.

### Solution to Problem

In order to solve the aforementioned problem, for example, the structures described in the claims are adopted.

The present application includes a plurality of means for solving the aforementioned problem, and an example is as follows.

There are provided a first arithmetic operation unit adapted to execute existing software, and a second arithmetic operation unit adapted to execute software different from the existing software, which are applied to a vehicle control device for controlling a vehicle.

Further, the vehicle control device includes:
an update determination unit adapted to determine whether the existing software can be updated to new software in the first arithmetic operation unit, based on a state of execution in the first arithmetic operation unit, and a structure of the new software to be newly implemented;
an update execution unit adapted to execute updating of the existing software according to a result of the determination by the update determination unit;
a resource monitoring unit adapted to monitor information about a resource used during an operation of the vehicle;
a resource information holding unit adapted to hold amount-of-resource-usage information, based on a resource usage state provided from the resource monitoring unit; and
a software arrangement change request transmission/reception unit adapted to make a request to the second arithmetic operation unit for arrangement change of a part of the structure of the new software or the existing software being executed by the first arithmetic operation unit.

Further, the update determination unit is adapted to determine whether the entire structure of the new software can be updated in the first arithmetic operation unit or a part of the structure of the new software should be changed in arrangement to be in the second arithmetic operation unit, based on information held by the resource information holding unit, and
when the update determination unit determines that a part of the structure of the new software should be changed in arrangement to be in the second arithmetic operation unit, the software arrangement change request transmission/reception unit makes a request to the second arithmetic operation unit, and
when the part of the structure of the new software is changed in arrangement, the software arrangement change request transmission/reception unit determines the part of the structure of the new software or the existing software to be arranged in the second arithmetic operation unit, in consideration of latencies in the first arithmetic operation unit and the second arithmetic operation unit which occur during execution of the new software.

### Advantageous Effects of Invention

According to the present invention, it is possible to realize updating of software, by changing the arrangement of the software among a plurality of arithmetic operation units, in consideration of latency during processing on the software for realizing control of the vehicle, even when the hardware resources may be exhausted.

Other problems, structures and effects than those described above will be clarified by the following description of embodiments.

### BRIEF DESCRIPTION OF DRAWINGS

FIG. 1 is a block diagram illustrating an overall structure of a vehicle control device according to an embodiment of the present invention.

FIG. 2 is a structural view illustrating an example of arrangement of vehicle control devices inside a vehicle, according to an embodiment of the present invention.

FIG. 3 is a view illustrating an example of existing software to be subjected to arithmetic processing according to an embodiment of the present invention.

FIG. 4 is a flowchart illustrating a processing procedure in a first arithmetic operation unit according to an embodiment of the present invention.

FIG. 5 is a view illustrating an example of an amount of resource usage according to an embodiment of the present invention.

FIG. 6 is a view illustrating an example of a worst amount of resource usage according to an embodiment of the present invention.

FIG. 7 is a flowchart illustrating a processing procedure in a resource monitoring unit according to an embodiment of the present invention.

FIG. 8 is a view illustrating an example of an amount of resource usage of new software according to an embodiment of the present invention.

FIG. 9 is a flowchart illustrating a processing procedure in an update determination unit according to an embodiment of the present invention.

FIG. 10 is a view illustrating an example of the result of determination according to an embodiment of the present invention.

FIG. 11 is a flowchart illustrating a processing procedure in an update execution unit according to an embodiment of the present invention.

FIG. 12 is a view illustrating an example of arrangement change request information 109 according to an embodiment of the present invention.

FIG. 13 is a flowchart illustrating a processing procedure in a software arrangement change request transmission/reception unit according to an embodiment of the present invention.

FIG. 14 is a view illustrating an example of software arrangement before updating of software according to an embodiment of the present invention.

FIG. 15 is a view illustrating an example of software arrangement after updating of software according to an embodiment of the present invention.

### DESCRIPTION OF EMBODIMENTS

Hereinafter, an embodiment (which will be referred to as “present example”, hereinafter) of the present invention will be described with reference to the accompanying drawings.

### [The Structure of Vehicle Control Device]

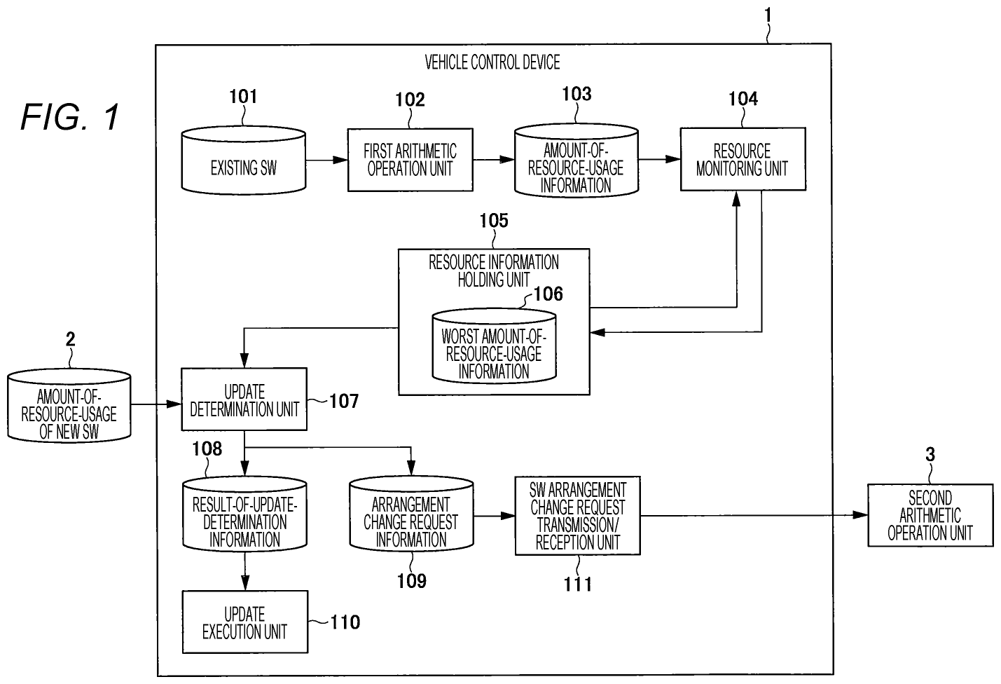

FIG. 1 is a block diagram illustrating an overall functional structure for updating software in a vehicle control device 1 in the present example.

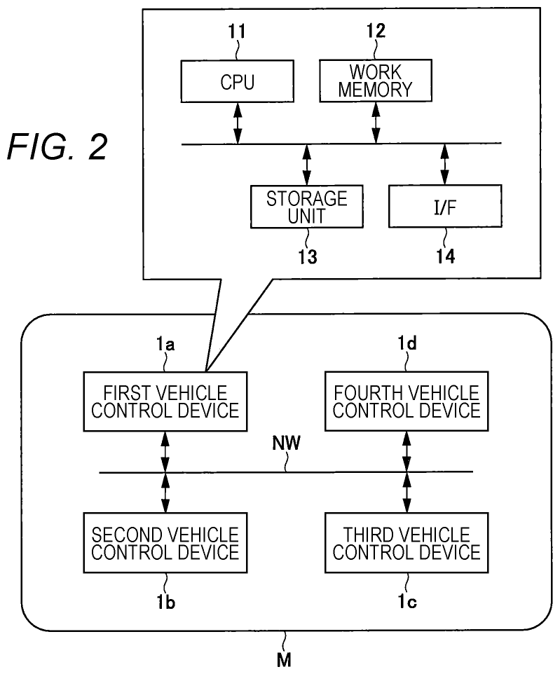

The vehicle control device 1 in the present example is a device mounted on a vehicle and adapted to control traveling and the like thereof. As will be described with reference to FIG. 2, a plurality of vehicle control devices 1 is installed in one vehicle, and the plural vehicle control devices 1 are connected to each other through a network. Each vehicle control device 1 is structured to be a computer adapted to execute software implemented therein, with an arithmetic operation unit, thereby performing operations for controlling the vehicle.

As illustrated in FIG. 1, in the vehicle control device 1, an existing-software holding unit 101 holds software (existing software) for performing operations. The existing software can be updated by new software supplied from the outside. Here, the new software is used for updating at least a part of the existing software. In the drawings, the software is abbreviated as “SW”.

When the vehicle control device 1 updates the existing software to the new software, amount-of-resource-usage information 2 about the new software is supplied to the vehicle control device 1. The amount-of-resource-usage information 2 about the new software is acquired from the outside together with the new software, but may also be generated in the vehicle at the time of reception of the new software.

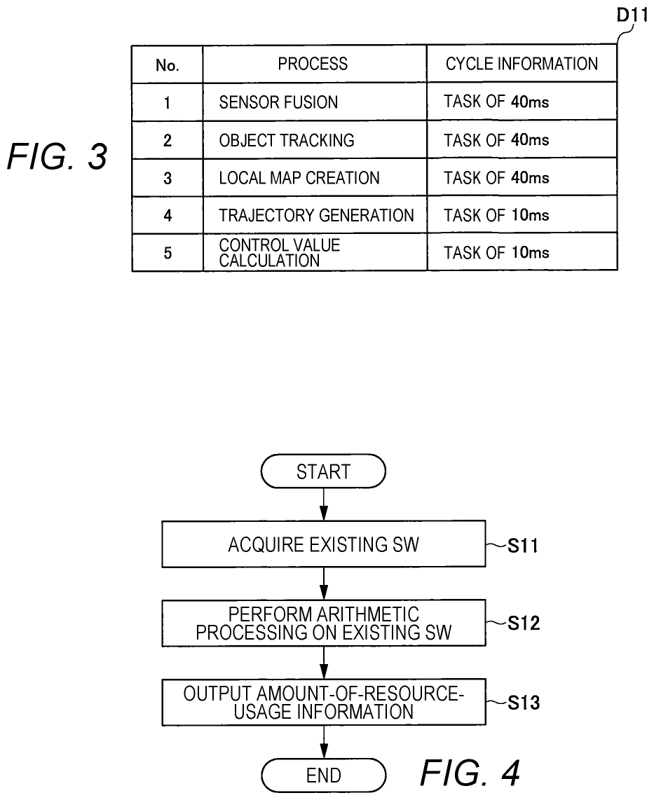

The structure of the vehicle control device 1 illustrated in FIG. 1 is a structure necessary when the vehicle control device 1 updates the existing software to the new software. The structures of the respective units illustrated in FIG. 1 are structured from software for operating the vehicle control device 1. Similarly, respective pieces of information illustrated in FIG. 1 are acquired by the same software. Incidentally, processing in the respective structures illustrated in FIG. 1 will be described in detail with reference to FIG. 3 and subsequent drawings.

First, the overall structure of the vehicle control device 1 illustrated in FIG. 1 will be described. The vehicle control device 1 includes the existing-software holding unit 101, a first arithmetic operation unit 102, amount-of-resource-usage information 103, a resource monitoring unit 104, a resource information holding unit 105, and worst amount-of-resource-usage information 106.

In addition, the vehicle control device 1 includes an update determination unit 107, result-of-update-determination information 108, arrangement change request information 109, an update execution unit 110, and a software arrangement change request transmission/reception unit 111. Incidentally, the amount-of-resource-usage information 103, the result-of-update-determination information 108, and the arrangement change request information 109 are held in respective corresponding holding units.

Further, a second arithmetic operation unit 3 is provided outside the vehicle control device 1 illustrated in FIG. 1. The second arithmetic operation unit 3 is provided in a plurality of other vehicle control devices provided in the vehicle. The structures of the plurality of vehicle control devices provided in the vehicle will be described later with reference to FIG. 2.

The existing-software holding unit 101 holds software to be executed by the vehicle control device 1. The existing software held by the existing-software holding unit 101 is executed by the first arithmetic operation unit 102.

The amount of resource usage during execution of software by the first arithmetic operation unit 102 is measured in the vehicle control device 1, and the measured amount-of-resource-usage information 103 is held.

The amount-of-resource-usage information 103 is transmitted to the resource monitoring unit 104 and monitored by the resource monitoring unit 104.

The result of monitoring by the resource monitoring unit 104 is held in the resource information holding unit 105.

The resource information holding unit 105 has the worst amount-of-resource-usage information 106, as one piece of the information held therein.

The update determination unit 107 determines whether or not it is possible to execute software in the first arithmetic operation unit 102, based on the amount-of-resource-usage information 2 about the new software, and the worst amount-of-resource-usage information 106 held in the resource information holding unit 105, thereby determining whether or not updating to the new software is possible. Then, the update determination unit 107 generates the result-of-update-determination information 108, based on the determination as to whether or not updating to the new software is possible.

The update execution unit 110 updates the existing software held in the existing-software holding unit 101 to the new software, based on the result-of-update-determination information 108.

Further, if the update determination unit 107 determines that it is impossible to perform updating to the new software in the first arithmetic operation unit 102, the update determination unit 107 generates arrangement change request information 109. The arrangement change request information 109 generated by the update determination unit 107 is transmitted from the software arrangement change request transmission/reception unit 111 to the second arithmetic operation unit 3 included in another vehicle control device.

The second arithmetic operation unit 3 having received the arrangement change request information 109 changes the software to be executed therein, based on the arrangement change request information 109. At this time, changing the software includes not only executing the new software but also executing at least a part of the existing software held in the existing-software holding unit 101.

Incidentally, the vehicle control device including the second arithmetic operation unit 3 also has a similar structure to that of the vehicle control device 1 illustrated in FIG. 1. Thus, this vehicle control device determines whether or not it is possible to execute, therein, the software designated to be changed in arrangement. If it is possible to execute the software, this vehicle control device performs the arrangement change based on the arrangement change request.

### [the Structure of Arrangement of a Plurality of Vehicle Control Devices]

FIG. 2 illustrates an example where a plurality of vehicle control devices is arranged in a vehicle M. Here, there is illustrated an example where there are arranged four vehicle control devices, which are a first vehicle control device 1a, a second vehicle control device 1b, a third vehicle control device 1c, and a fourth vehicle control device 1d. The respective vehicle control devices 1a to 1d are connected to each other through a network NW, and are enabled to transmit and receive data to and from each other. Further, each of the vehicle control devices 1a to 1d connected to the network NW includes a transmission/reception unit or a communication port for exchanging data with the outside of the vehicle and the like, and is enabled to acquire information such as new software from the outside.

Each of the vehicle control devices 1a to 1d includes an arithmetic operation unit (corresponding to the arithmetic operation unit 102 in FIG. 1) and, further, has the structure illustrated in FIG. 1 in order to update software to be executed by the arithmetic operation unit.

Here, the hardware structure of each of the vehicle control devices 1a to 1d will be described. For example, the first vehicle control device 1a includes a central processing unit (CPU) 11, a work memory 12, a storage unit 13, and an interface (I/F) 14, which are connected to each other so as to transfer data to and from each other.

The CPU11 executes, in the work memory 12, programs (software) stored in the storage unit 13. As a result, the respective processing units illustrated in FIG. 1 are structured in the work memory 12.

The storage unit 13 stores programs for controlling the vehicle and, further, stores images, control data, and the like. The programs stored in the storage unit 13 also include a program for performing software updating processing.

The interface 14 performs processing for inputting detection data from a camera and various sensors, and processing for outputting data for controlling the vehicle.

The other vehicle control devices 1b to 1d than the first vehicle control device 1a also have the same structure as that of the first vehicle control device 1a.

In the following description, the vehicle control device 1 will refer to any one of the plurality of vehicle control devices 1a to 1d.

### [Example of Software Subjected to Arithmetic Processing by the Vehicle Control Device]

FIG. 3 is a view illustrating an example of data D11 regarding processes of the existing software 101 to be subjected to arithmetic processing in the vehicle control device 1, and further regarding cycle information thereabout.

Here, there are illustrated sensor fusion, object tracking, local map creation, trajectory generation, and control value calculation, as examples of processes of the existing software 101 to be subjected to arithmetic processing in the vehicle control device 1.

Each process of the software has a task indicating a cycle of the arithmetic processing. For example, in the example of the data D11 in FIG. 3, the arithmetic processing for the sensor fusion, the object tracking, and the local map creation is performed in a cycle of 40 ms. Further, for the trajectory generation and the control value calculation, the arithmetic processing is performed in a cycle of 10 ms.

### [Arithmetic Processing in the Arithmetic Operation Unit]

FIG. 4 is a flowchart illustrating a processing procedure in the first arithmetic operation unit 102.

First, the first arithmetic operation unit 102 acquires the existing software 101 (step S11). Then, the first arithmetic operation unit 102 performs arithmetic processing on the acquired software, thereby executing control and the like based on the software (step S12).

Here, the first arithmetic operation unit 102 outputs amount-of-resource-usage information 103 about during the arithmetic processing in the step S12 (step S13). These processing in the steps S11 to S13 is repeated during operations of the first arithmetic operation unit 102.

### [Examples of the Amount of Resource Usage and the Worst Amount of Resource Usage]

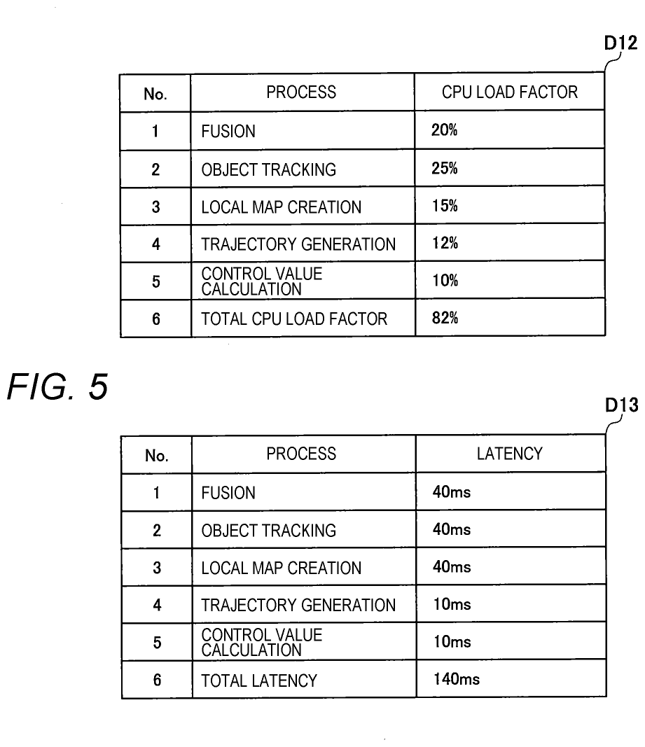

FIG. 5 is views illustrating an example of the amount-of-resource-usage information 103 in the present example. The amount-of-resource-usage information 103 is information acquired during the execution of software by the first arithmetic operation unit 102, and changes at all times during the arithmetic processing.

In this case, the amount-of-resource-usage information 103 includes information D12 about the CPU load factor of when the first arithmetic operation unit 102 performs arithmetic processing on the existing software 101, and information D13 about the latency of when the first arithmetic operation unit 102 performs arithmetic processing on the existing software 101.

The information D12 about the CPU load factor is indicated as CPU load factors during arithmetic operations.

Here, for example, the CPU load factor of the sensor fusion is 20%, the CPU load factor of the object tracking is 25%, the CPU load factor of the local map creation is 15%, the CPU load factor of the trajectory generation is 12%, and the CPU load factor of the control value calculation is 10%.

The information D12 about the CPU load factor further includes information about the total CPU load factor (82% in this case), which is the total sum of the aforementioned CPU load factors.

In the information D13 about the latency, the processing times during arithmetic operations are indicated as latencies.

For example, the latency of the sensor fusion is 40 ms, the latency of the object tracking is 40 ms, the latency of the local map creation is 40 ms, the latency of the trajectory generation is 10 ms, and the latency of the control value calculation is 10 ms.

The information D13 about the latency also includes information about the total latency (140 ms in this case), which is the total sum of the aforementioned latencies.

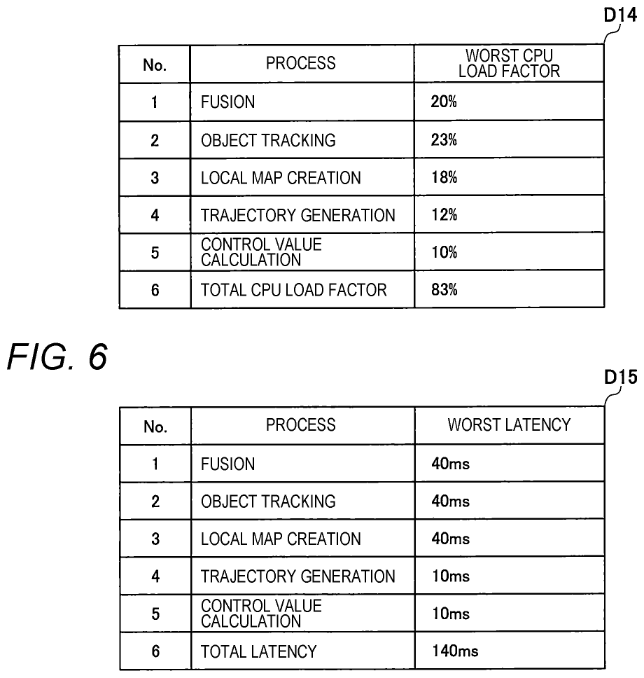

FIG. 6 is views illustrating an example of the worst amount-of-resource-usage information 106 resulted from monitoring by the resource monitoring unit 104.

The worst amount-of-resource-usage information 106 includes information D14 about the worst CPU load factor of when the first arithmetic operation unit 102 performs arithmetic processing on the existing software 101, and information D15 about the worst latency of when the first arithmetic operation unit 102 performs arithmetic processing on the existing software 101.

The information D14 about the worst CPU load factor, and the information D15 about the worst latency are set to be the worst values (maximum values) out of the values obtained as the CPU-load-factor information D12 and the latency information D13 illustrated in FIG. 5, through resource monitoring processing illustrated in the subsequent FIG. 7.

For example, in FIG. 6, the worst CPU load factor of the object tracking is 23%, the worst CPU load factor of the local map creation is 18%, and the total worst CPU load factor is 83%, which are different from the CPU load factors illustrated in FIG. 5.

### [Resource Monitoring Processing]

FIG. 7 is a flowchart illustrating a processing procedure in the resource monitoring unit 104 for obtaining the information illustrated in FIGS. 5 and 6.

First, the resource monitoring unit 104 acquires the amount-of-resource-usage information 103 from the first arithmetic operation unit 102 (step S21). Further, the resource monitoring unit 104 acquires the worst amount-of-resource-usage information 106 held by the resource information holding unit 105 (step S22).

Next, the resource monitoring unit 104 determines whether or not the value of the resource for each software indicated by the amount-of-resource-usage information 103 acquired in the step S21 is larger than the value in the worst amount-of-resource-usage information 106 acquired in the step S22 (step S23).

If the determination in the step S23 results in that the value of the resource for each software is larger than the value in the worst amount-of-resource-usage information 106 (YES in the step S23), the resource monitoring unit 104 updates the value in the worst amount-of-resource-usage information 106, based on the value in the amount-of-resource-usage information 103 (step S24). Then, the resource monitoring unit 104 outputs the updated value in the worst amount-of-resource-usage information 106 and causes the resource information holding unit 105 to hold it (step S25).

If the determination in the step S23 results in that the value of the resource for each software is equal to or smaller than the value in the worst amount-of-resource-usage information 106 (NO in the step S23), the resource monitoring unit 104 ends the resource monitoring processing, without updating the value in the worst amount-of-resource-usage information.

The resource monitoring unit 104 repeatedly executes the processing of the flowchart of FIG. 7.

Incidentally, in a case where the worst amount-of-resource-usage information D14 and D15 illustrated in FIG. 6 is set, if the information of the amount-of-resource-usage information D12 and D13 illustrated in FIG. 5 is acquired, the CPU load factor of the object tracking is 25% and has a value larger than the worst CPU load factor, which is 23%. Accordingly, the resource monitoring unit 104 updates the worst CPU load factor to 25% in the step S24.

### [The Amount of Resource Usage of New Software]

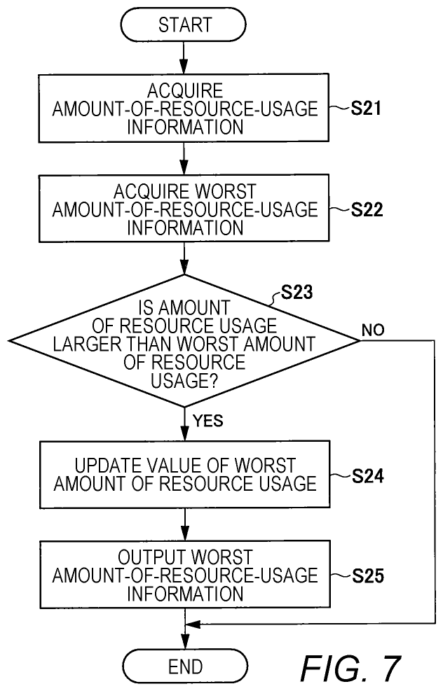

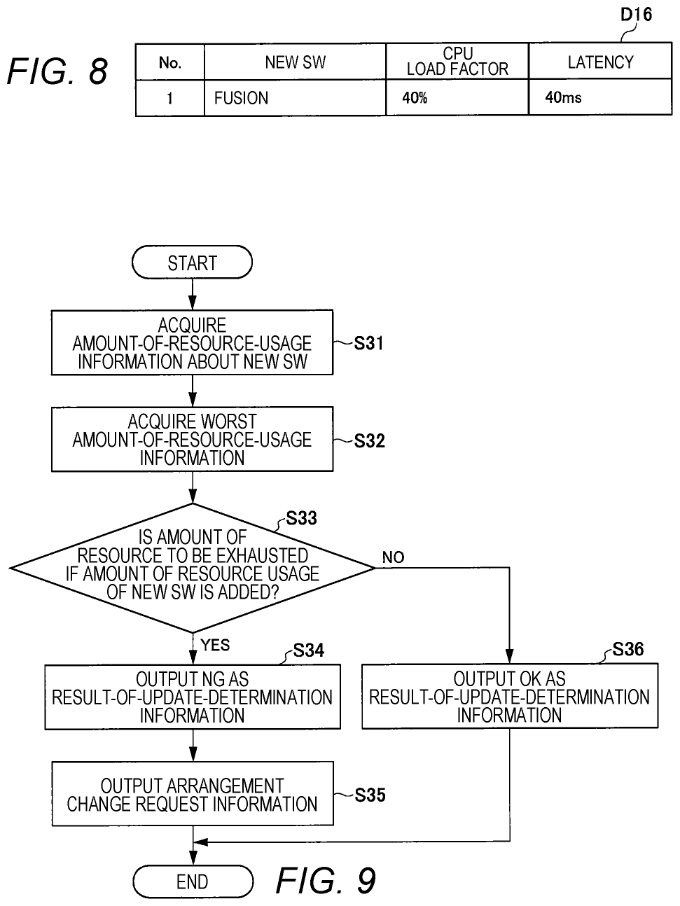

FIG. 8 is a view illustrating an example of the amount-of-resource-usage information 2 about new software in the present example.

Here, it is assumed that the fusion process in the existing software 101 is updated by updating the software.

Regarding the fusion function to be newly updated, the amount D16 of resource usage of the new software illustrated in FIG. 8 indicates that the updated fusion has a CPU load factor of 40%, and a latency of 40 ms.

### [Update Determination Processing]

FIG. 9 is a flowchart illustrating a processing procedure in the update determination unit 107.

First, the update determination unit 107 acquires the amount-of-resource-usage information 2 about new software (step S31). The amount-of-resource-usage information 2 about the new software is acquired at an arbitrary timing to start updating. Here, the arbitrary timing to start updating may be, for example, any timing during stoppage of the vehicle, during parking of the vehicle, during charging of the vehicle (in cases of an electric vehicle or a chargeable hybrid vehicle), or at the time of a notification from the user interface of the vehicle, which enables appropriate updating during time periods other than during traveling of the vehicle.

Then, the update determination unit 107 acquires the worst amount-of-resource-usage information 106 held in the resource information holding unit 105 (step S32).

Next, the update determination unit 107 determines whether the hardware resource will be exhausted, if updating is performed with the new software, by adding the values in the amount-of-resource-usage information 2 about the new software to the values for the software other than the to-be-updated software in the worst amount-of-resource-usage information 106 (step S33).

For example, in the case of the amount D16 of resource usage of the new software illustrated in FIG. 8 (the CPU load factor of the fusion is 40%, and the latency of the fusion is 40 ms), the update determination unit 107 updates the values for the fusion in the worst amount-of-resource-usage information D14 and D15 illustrated in FIG. 6 with the amount D16 of resource usage of the new software, and, further, the update determination unit 107 determines the total value of them. If the total value exceeds a certain CPU load factor (for example, 100% or 95% with a margin), or if the total sum of the latencies exceeds the processing cycle, the update determination unit 107 determines that the hardware resource will be exhausted. The CPU load factor for determining that the hardware resource will be exhausted may be a value lower than 100%, such as a value of 95% or 90% with a margin. Similarly, the latency for the determination may be a time period shorter than the processing cycle.

Further, if it is determined in the determination in the step S33 that the hardware resource will be exhausted (YES in the step S33), the update determination unit 107 outputs “NG” indicating that the updating is not possible, as result-of-update-determination information 108 (step S34).

Further, the update determination unit 107 outputs arrangement change request information 109 (step S34), and ends the update determination processing.

Further, if it is determined in the determination in the step S33 that the hardware resource will not be exhausted (NO in the step S33), the update determination unit 107 outputs “OK” indicating that the updating is possible, as result-of-update-determination information 108 (step S36), and ends the update determination processing.

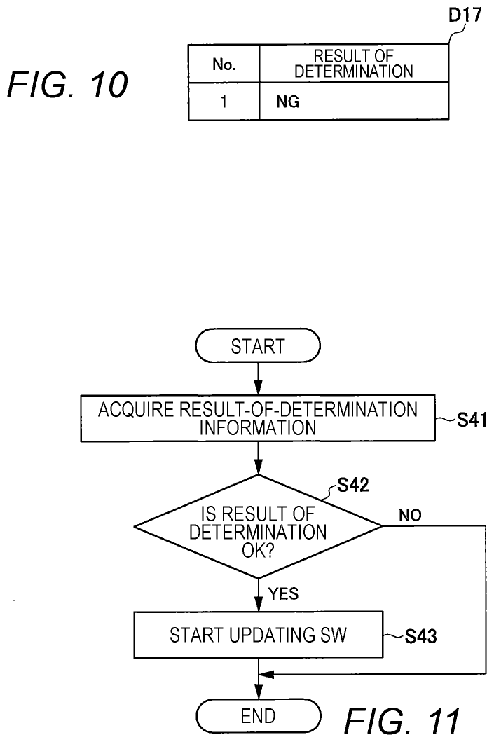

FIG. 10 illustrates an example of the result-of-update-determination information 108. Here, there is illustrated information D17 about the result of update determination of “NG” In the case of the result-of-update-determination information 108 illustrated in FIG. 10, an arrangement change request is made. On the other hand, although not illustrated, in a case where the result of update determination is “OK”, the update execution unit 110 executes updating.

### [Update Execution Processing]

FIG. 11 is a flowchart illustrating a processing procedure in execution of updating by the update execution unit 110.

The update execution unit 110 acquires the result-of-update-determination information 108 (step S41). Then, the update execution unit 110 determines whether or not the acquired result of determination is “OK” (step S42). If it is determined in the step S42 that the result of determination is “OK” (YES in the step S42), the update execution unit 110 executes updating with the prepared new software (step S43), and ends the update execution processing. On the other hand, if it is determined in the step S42 that the result of determination is “NG” (NO in the step S42), the update execution unit 110 ends the update execution processing, without executing updating.

### [Example of Arrangement Change Request]

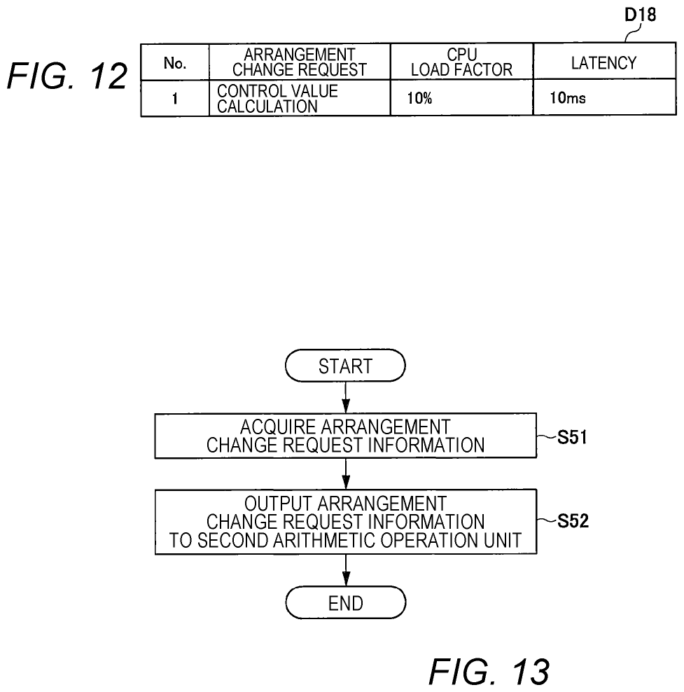

FIG. 12 is a view illustrating an example of arrangement change request information 109 in the present example.

The arrangement change request information D19 in the example of FIG. 12 designates the control value calculation as software to be changed in arrangement, including CPU-load-factor information (10%) and latency information (10 ms) about the software of the control value calculation.

Incidentally, the software to be changed in arrangement is selected by the update determination unit 107 or the like, in order to prevent the hardware resource from being exhausted, in terms of the CPU load factor and the latency, if updating to the new software is performed. Namely, it is determined as to which software should be requested to be changed in arrangement so as to be executed by another arithmetic operation unit, in consideration of the latencies in the first arithmetic operation unit 102 and another arithmetic operation unit (the second arithmetic operation unit 3) which may occur during execution of the new software.

### [Processing for Transmitting Arrangement Change Request]

FIG. 13 is a flowchart illustrating a processing procedure in the software arrangement change request transmission/reception unit 111 in the present example.

First, the software arrangement change request transmission/reception unit 111 acquires the arrangement change request information 109 (step S51). Then, the software arrangement change request transmission/reception unit 111 outputs the acquired arrangement change request information 109 to the second arithmetic operation unit 3 in another vehicle control device (step S52), and ends the processing for transmitting arrangement change request.

Incidentally, the second arithmetic operation unit 3 having received the arrangement change request has a similar structure to the structure in FIG. 1 and, thus, determines whether or not the hardware resource will be exhausted if it executes the software requested to be changed in arrangement. Then, as a result thereof, if the second arithmetic operation unit 3 accepts the arrangement change request, the second arithmetic operation unit 3 makes a reply of “the change request is OK” to the software arrangement change request transmission/reception unit 111.

Further, information (program data) about the corresponding software to be changed in arrangement is also transferred from the vehicle control device 1 including the first arithmetic operation unit 102 to the vehicle control device including the second arithmetic operation unit 3. Alternatively, the program data of the software may be held in a storage unit in the vehicle control device 1 including the first arithmetic operation unit 102, and the vehicle control device including the second arithmetic operation unit 3 may read and execute the corresponding program data through the network NW.

### [Example of Software Arrangement Change]

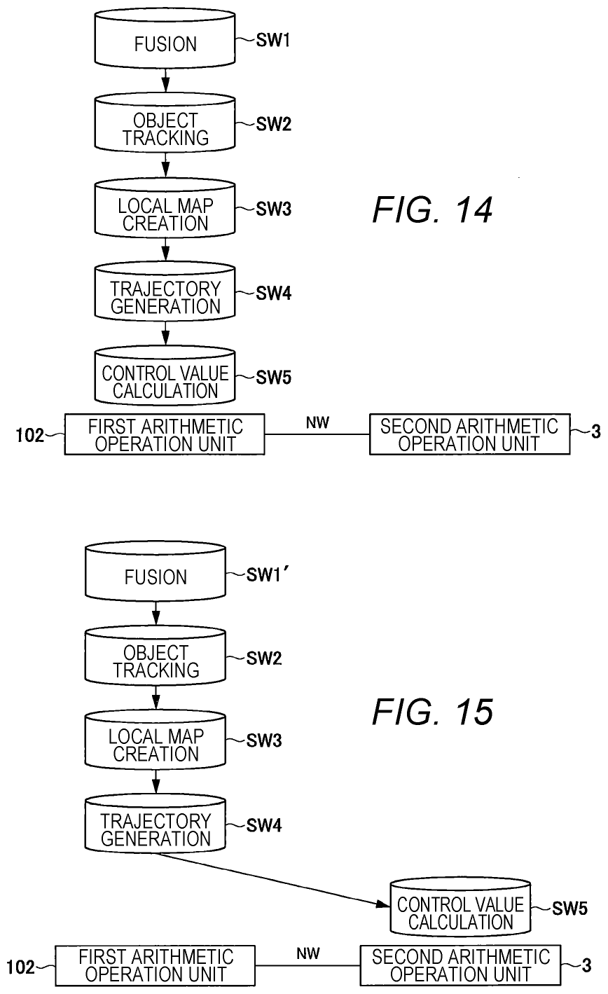

FIGS. 14 and 15 are views illustrating the difference in software arrangement between before and after software updating.

For example, as illustrated in FIG. 14, it is assumed that the first arithmetic operation unit 102 is structured to execute the respective pieces of software for fusion SW1, object tracking SW2, local map creation SW3, trajectory generation SW4, and control value calculation SW5, while the second arithmetic operation unit 3 is structured to execute other software.

For example, it is assumed that the fusion SW1 has been updated to fusion SW1′ as new software, in this state. In this case, if it is determined that the hardware resource of the first arithmetic operation unit 102 will be exhausted in this state, the arrangement is changed as illustrated in FIG. 15.

Namely, as illustrated in FIG. 15, the fusion SW1′, the object tracking SW2, the local map creation SW3, and the trajectory generation SW4 are executed by the first arithmetic operation unit 102. Further, the control value calculation SW5 is executed by the second arithmetic operation unit 3.

In the example of FIG. 15, the fusion SW1′ as the new software is implemented by the first arithmetic operation unit 102. However, conversely, the fusion SW1′ as the new software may be executed by the second arithmetic operation unit 3. Alternatively, all the software related to the updating may be executed by the second arithmetic operation unit 3. Also, a part of the fusion SW1′ as the new software may be implemented by the first arithmetic operation unit 102, while the remaining part of the fusion SW1′ may be executed by the second arithmetic operation unit 3.

It is determined as to which software should be executed by the second arithmetic operation unit 3, in consideration of the latencies in the first arithmetic operation unit 102 and the second arithmetic operation unit 3 which may occur during execution of the new software.

By performing the processing described above, the vehicle control device in the present example is caused to perform processing for changing software arrangement among a plurality of arithmetic operation units, while considering the latency during processing the software. Therefore, even in a case where the hardware resource will be exhausted in one arithmetic operation unit due to updating of the software, the updating is performed in cooperation with another arithmetic operation unit, which enables appropriately updating the software.

Furthermore, the update determination unit 107 determines whether or not updating is possible, based on the CPU load factor and the latency. This makes it relatively easy to determine the resource usage state, which advantageously enables easily determining whether or not updating is possible with a small number of arithmetic operations. Incidentally, determining whether or not updating is possible based on the CPU load factor and the latency is an example. It is also possible to perform the determination, based on the amount of memory usage, in addition to the CPU load factor and the latency. By determining the resource usage state based on the CPU load factor, the latency, and the amount of memory usage, it is possible to determine the resource usage state more accurately.

Alternatively, the update determination unit 107 may determine the resource usage state, based on any one of the CPU load factor, the latency, and the amount of memory usage. This permits evaluating only one numerical value in determining the resource usage state, thereby making it easy to determine the resource usage state.

Furthermore, as illustrated in FIG. 15, the structure is changed such that the first arithmetic operation unit 102 implements the new software, while the second arithmetic operation unit 3 implements a part of the existing software. This enables updating, by effectively using the hardware resources of the respective arithmetic operation units. In this case, similarly, the determination of arrangement change can be performed, based on the resource usage state, such as the CPU load factor, the latency, and the amount of memory usage, which enables optimal arrangement change.

### [Examples of Modifications]

Incidentally, the aforementioned embodiment has been described in detail, for the purpose of explaining the present invention in such a way as to facilitate understanding the present invention, and the present invention is not necessarily limited to structures including all the described structures.

For example, regarding timing at which the vehicle control device 1 executes updating, updating can be performed at an arbitrary timing of the vehicle. Namely, it is possible to determine whether the entire structure of new software can be updated with the first arithmetic operation unit 102 or whether a part of the structure of the new software should be changed in arrangement to be in the second arithmetic operation unit 3, based on the worst amount-of-resource-usage information 106 (at least any one of the load factor of the central processing unit, the amount of memory usage, and the latency), which is a part of information held by the resource information holding unit 105, at an arbitrary timing of the vehicle. This enables appropriate updating.

Here, the arbitrary timing of the vehicle may be, for example, any timing during stoppage of the vehicle, during parking of the vehicle, during charging of the vehicle (in cases of an electric vehicle or a chargeable hybrid vehicle), or at the time of a notification from the user interface of the vehicle. This enables appropriate updating during time periods other than during traveling of the vehicle.

Further, in the aforementioned embodiment, there has been described an example where software is changed in arrangement to be in the arithmetic operation unit in another vehicle control device outside the vehicle control device. However, the place at which the arithmetic operation unit is arranged is not limited to that in the aforementioned embodiment, and the present invention can be widely applied to systems incorporating a plurality of arithmetic operation units.

Further, in the structural views in FIGS. 1 and 2, there are illustrated control lines and information lines considered to be necessary for description, and not all control lines and information lines necessary for products are illustrated. It may be considered that almost all the structures are connected to each other, in actual.

Furthermore, the processing flows of the flowcharts illustrated in FIG. 4 and the subsequent drawings are also merely examples. The order of processing can be partially changed, or a plurality of processing may be executed simultaneously, as long as the same result can be obtained from the processing.

Further, the processing performed in the vehicle control device according to the present invention is performed by execution of a program (software). For example, a program for executing the processing described in the embodiment can be implemented in an existing information processing device (computer), so that the existing information processing device can function as the vehicle control device according to the present invention. In this case, information about the program can be placed in any of various types of recording media, such as a memory, a hard disk, or a solid state drive (SSD), an IC card, an SD card, and an optical disk.

Further, in the structure illustrated in FIG. 2, there is illustrated an example where the vehicle control device is structured by an information processing device (computer) executed under the control of a CPU. However, a part or all of the functions performed by the vehicle control device may be realized by dedicated hardware, such as a field programmable gate array (FPGA) or an application specific integrated circuit (ASIC).

### REFERENCE SIGNS LIST

1, 1a, 1b, 1c, 1d vehicle control device
2 amount-of-resource-usage information about software
3 second arithmetic operation unit
11 CPU
12 work memory
13 storage unit
14 interface
101 existing-software holding unit
102 first arithmetic operation unit
103 amount-of-resource-usage information
104 resource monitoring unit
105 resource information holding unit
106 worst amount-of-resource-usage information
107 update determination unit
108 result-of-update-determination information
109 arrangement change request information
110 update execution unit
111 software arrangement change request transmission/reception unit

1. A vehicle control device comprising a first arithmetic operation unit adapted to execute existing software and a second arithmetic operation unit adapted to execute software different from the existing software, for controlling a vehicle, the vehicle control device comprising:
an update determination unit adapted to determine whether the existing software can be updated to new software in the first arithmetic operation unit, based on a state of execution in the first arithmetic operation unit and a structure of the new software to be newly implemented;
an update execution unit adapted to execute updating of the existing software according to a result of the determination by the update determination unit;
a resource monitoring unit adapted to monitor information about a resource used during an operation of the vehicle;
a resource information holding unit adapted to hold amount-of-resource-usage information, based on a resource usage state provided from the resource monitoring unit; and
a software arrangement change request transmission/reception unit adapted to make a request to the second arithmetic operation unit for arrangement change of a part of the structure of the new software or the existing software being executed by the first arithmetic operation unit;
wherein the update determination unit is adapted to determine whether the entire structure of the new software can be updated in the first arithmetic operation unit or a part of the structure of the new software should be changed in arrangement to be in the second arithmetic operation unit, based on information held by the resource information holding unit, and
when the update determination unit determines that a part of the structure of the new software should be changed in arrangement to be in the second arithmetic operation unit, the software arrangement change request transmission/reception unit makes a request to the second arithmetic operation unit, and
when the part of the structure of the new software is changed in arrangement, the software arrangement change request transmission/reception unit determines the part of the structure of the new software or the existing software to be arranged in the second arithmetic operation unit, in consideration of latencies in the first arithmetic operation unit and the second arithmetic operation unit which occur during execution of the new software.

2. The vehicle control device according to claim 1, wherein the update determination unit is adapted to determine whether the entire structure of the new software can be updated in the first arithmetic operation unit or a part of the structure of the new software should be changed in arrangement to be in the second arithmetic operation unit, based on at least one of a load factor of a central processing unit, an amount of memory usage, and a latency, which are a part of the information held by the resource information holding unit.

3. The vehicle control device according to claim 1, wherein the update determination unit is adapted to determine whether the entire structure of the new software can be updated in the first arithmetic operation unit or a part of the structure of the new software should be changed in arrangement to be in the second arithmetic operation unit, based on at least one of a load factor of a central processing unit, an amount of memory usage, and a latency, which are a part of the information held by the resource information holding unit, at an arbitrary timing of the vehicle.

4. The vehicle control device according to claim 3, wherein the arbitrary timing is any one of timing during stoppage of the vehicle, timing during parking of the vehicle, timing during charging of the vehicle, or timing at the time of a notification from a user interface of the vehicle.

5. The vehicle control device according to claim 1, wherein when the update determination unit determines that a part of the structure of the new software should be changed in arrangement to be in the second arithmetic operation unit, software to be changed in arrangement to be in the second arithmetic operation unit is selected from the existing software, in such a way as to optimize an amount of usage of a hardware resource.

6. The vehicle control device according to claim 5, wherein the hardware resource is at least one of a load factor of a central processing unit, an amount of memory usage, and a latency.
